(19) United States
(12) Patent Application Publication
(10) Pub. No.: US 2005/0212978 A1
(43) Pub. Date: Sep. 29, 2005

(54) Electronic device and control method used therein

(76) Inventors: Shih-Pin Lo, Taoyuan City (TW); Ching-Fu Cheng, Sanchong City (TW)

Correspondence Address: RABIN & Berdo, PC, 1101 14TH STREET, NW, SUITE 500, WASHINGTON, DC, 20005, US

(21) Appl. No.: 10/919,286

(22) Filed: Aug. 17, 2004

(30) Foreign Application Priority Data
Mar. 26, 2004 (TW) 93108249

(51) Int. Cl. H04N 7/173; H04N 7/16; H04N 5/50

(52) U.S. Cl. 348/731; 725/100; 725/131; 725/151

(57) ABSTRACT

An electronic device and control method used therein. The electronic device comprises a tuner, a video capture device, and a potential selector. When a first potential is applied with the potential selector, both the tuner and the video capture device are powered by a first power source of the first potential, and, when a second potential is applied with the potential selector, only the video capture device is powered by a second power source of the second potential.

### BACKGROUND OF THE INVENTION

1. Field of the Invention

The present invention is related to a TV box, and more particularly to a TV box capable of switching from first potential to second potential, and accordingly determining whether input power is supplied to the TV tuner and the video capture device both or video device only.

2. Description of the Related Art

Generally, a TV box comprises a video capture device and a TV tuner. The video capture device communicates with a personal computer through a universal serial bus (USB) port and, the TV tuner receives and down convert TV signal into a video base-band signal.

FIG. 5 is block diagram of a conventional TV box. The TV box 50 is coupled to a USB port of personal computer 51 and an additional power-supply 52. The video capture device 55 and the TV tuner 56 communicate with the personal computer 51 through the USB port and are powered by the power supply 52. Thus, the user is able to capture video images from digital camera 53 or receive TV signal 54 through TV box 50 by using the personal computer 51.

The TV tuner 56, however, consumes large power, above 1.5 watts, making the whole TV box requiring power more than the USB port able to supply. Hence, the TV tuner 56 cannot operate when the TV box 50 is supplied only by USB bus power.

Thus, when the conventional TV box 50 operates without the power supply 52, both of the video capture device 55 and the TV tuner 56 are not able to operate even if the TV box 50 is coupled to a personal computer 51 through the USB port.

### SUMMARY OF THE INVENTION

The present invention provides a TV box, and a video capture device thereof capable of normal operation when powered only by a USB port of a host.

Accordingly, the present invention provides a TV box comprising a tuner, a video capture device, and a potential selector. When the potential selector is applied with a first potential, both the tuner and the video capture device are powered by a first power source. When the potential selector is applied with a second potential, only the video capture device is powered by a second power source.

Furthermore, the present invention provides a method for controlling an electronic device having a TV tuner and a video capture device. The electronic device is capable of being coupled to a first power source of a first potential and a second power source of a second potential. Initially, it is determined whether the first potential is supplied to the electronic device. When the first potential is supplied to the electronic device, power is supplied to the first circuit and the second circuit. Finally, power is supplied to the second circuit when the first potential is not supplied to the electronic device.

Therefore, according to the TV box of the present invention, the video capture device operable when TV box is coupled to USB potential, thereby improving convenience especially in outdoors.

### BRIEF DESCRIPTION OF THE DRAWINGS

The present invention can be more fully understood by reading the subsequent detailed description in conjunction with the examples and references made to the accompanying drawings, wherein:

FIG. 1 is a diagram of a TV box of present invention;

FIG. 2 is a diagram of potential selector 1 shown in FIG. 1;

FIG. 3 is a diagram of—alternative way to implement the potential detector 10 in FIG. 2;

FIG. 4 is a flow chart of control method of the present invention;

FIG. 5 is a block diagram of a conventional TV box; and

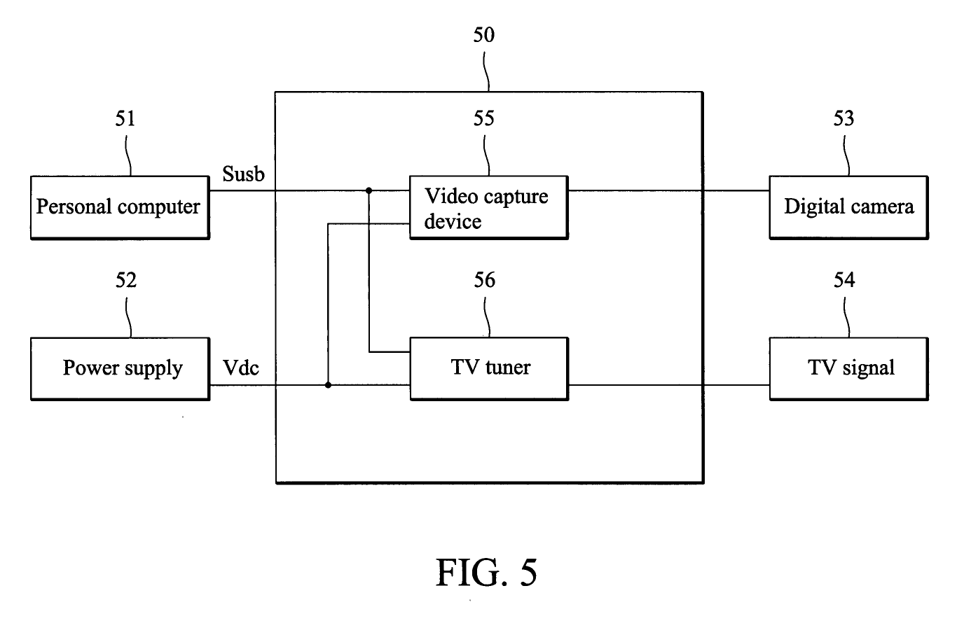

FIG. 6 is a diagram of a TV box comprising a protection circuit according to an embodiment of the invention.

### DETAILED DESCRIPTION OF THE INVENTION

The object of the present invention provides a TV box, and a video capture device thereof capable of normal operation when the TV box is powered only by a USB port of a computer host.

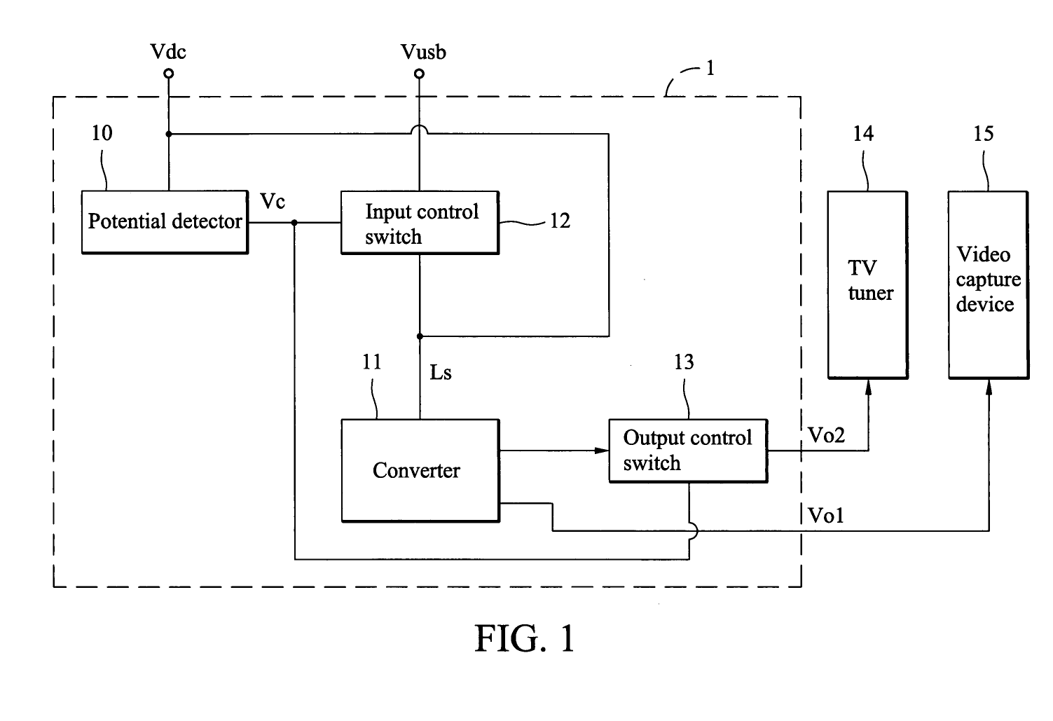

FIG. 1 is a diagram of a TV box of an embodiment of the present invention. The TV box comprises a potential selector 1, a TV tuner 14, and video capture device 15. The input of the potential selector 1 is coupled to a first potential Vdc and a second potential Vusb, and the output thereof is coupled to a TV tuner 14 and a video capture device 15. The first potential Vdc is supplied by an adapter or other power source and the second potential Vusb is supplied by a USB interface of a computer host (not shown).

Initially the input control switch 12 connects the second potential Vusb and a power line Ls. When the potential selector 1 is coupled to the first potential Vdc and the second potential Vusb, the potential detector 10 outputs a control signal Vc. Thus, the input control switch 12 closes the connection between the second potential Vusb and the power line Ls, and transmits the power of the first potential Vdc to the converter 11 after receiving the control signal Vc. According to the first potential Vdc, the converter 11 provides a third potential Vo1 and a fourth potential Vo2 for the video capture device 15 and the TV tuner 14, respectively.

Additionally, when the potential selector 1 is coupled only to the USB potential Vusb, the potential detector 10 provides the control signal Vc with zero potential to an output control switch 13 to close the connection between the converter 11 and the TV tuner 14. Hence, the converter 11 provides the third potential Vo1 to the video capture device 15.

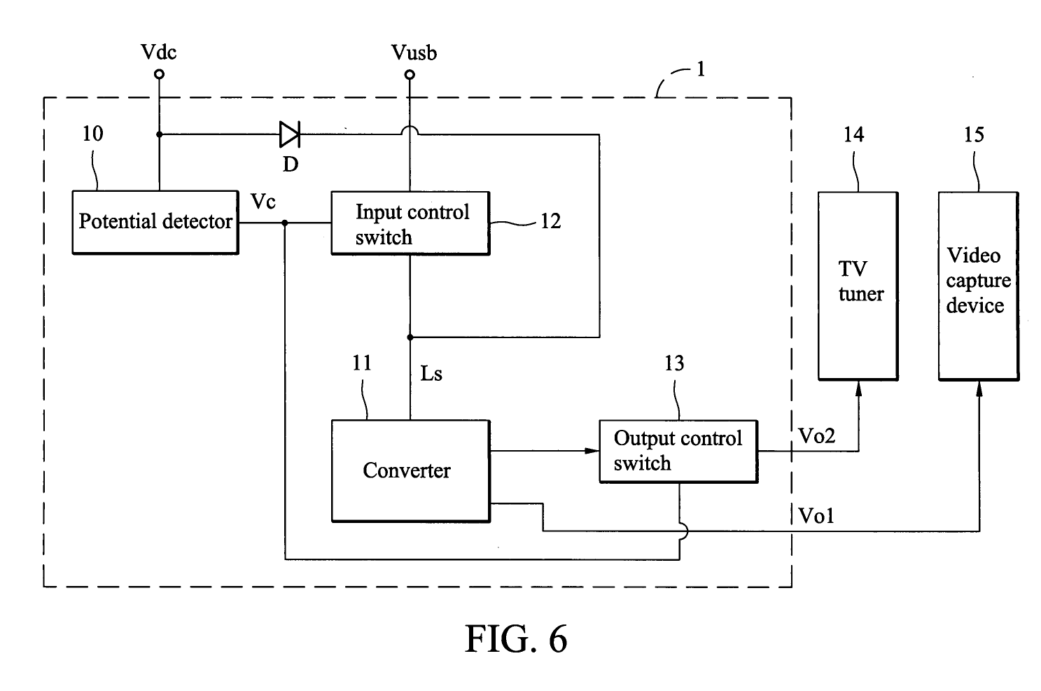

Furthermore, diode D is provided between the first potential Vdc and a power line Ls as showed in FIG. 6. When the power supply is removed from the TV box, by using the diode D, it is able to prevent that an instant high current generated by switched on the input control switch 12 forwards to the potential detector 10, thereby protecting the TV box.

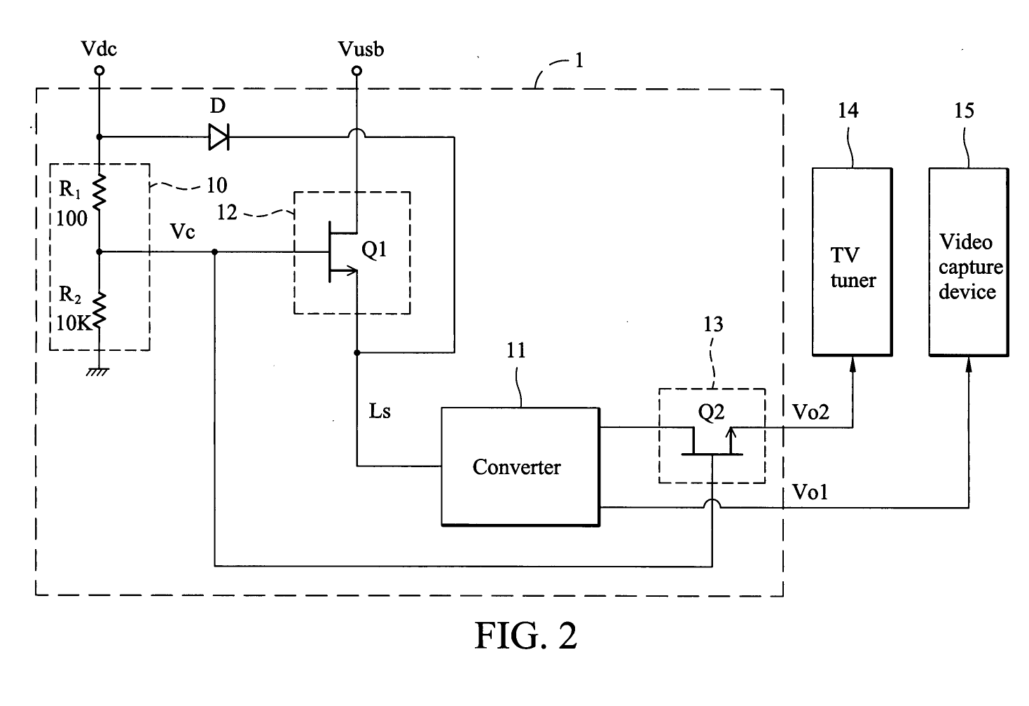

FIG. 2 is a diagram of the potential selector 1 of FIG. 1 of the present invention. The potential detector 10 comprises a first resistor R1 and a second resistor R2 coupled in series capable of outputting the control signal Vc across the second resistor R2. The input control switch 12 and the output control switch 13 are a first transistor Q1 and a second transistor Q2, respectively. Operation of the first transistor Q1 and the second transistor Q2 is mutually exclusive. For example, the first transistor Q1 is turned on if the second transistor Q2 is turned off.

If the potential Vdc is about 12 volts, the USB potential Vusb is about 5 volts, the threshold voltage Vt1 of the first transistor Q1 is about −1 volt, the threshold voltage Vt2 of the second transistor Q2 is about 1 volt, the resistance of the fist resistor R1 is about 100 ohms, and the resistance of the second resistor R2 is about 10 k ohms. Thus the control signal Vc or the gate voltage of the first transistor Q1 is equal to 11.88 volts calculated by the divided potential of the second resistor R2.

When the potential selector 1 is coupled to the potential Vdc and the USB potential Vusb, the reverse bias VGS1 of the first transistor Q1 is −0.12 volts, which is calculated by subtracting 12 from 11.88, and the forward bias VGS2 of the second transistor Q2 is 11.88V. Thus, the first transistor Q1 is turned off when the reverse bias VGS1 is smaller than its threshold voltage Vt1. Similarly, the second transistor Q2 is turned on when the forward bias VGS2 is greater than its threshold voltage Vt2.

When the first transistor Q1 is turned off and the second transistor Q2 is turned on, the first potential Vdc is coupled to the converter 11 through the power line Ls. Thus, the converter 11 is capable of outputting both the third potential Vo1 and the fourth potential Vo2 for the video capture device 15 and the TV tuner 14. The third potential Vo1 is about 5 volts and the fourth potential Vo2 is about 3.3 volts.

In the invention, the first transistor Q1 can be a p-channel metal-oxide-semiconductor (PMOS), and the second transistor Q2 can be an N-channel metal-oxide-semiconductor (NMOS). Additionally, the first transistor Q1 and the second transistor Q2 can be implemented by any kind of electronic switches such as a bipolar-junction-transistor (BJT), a field effect transistor (FET), and the like.

If the potential between drain-source VDS1 of the first transistor Q1 is about 0.5, when the potential selector 1 is coupled only to the second potential Vusb, the control signal Vc is 0 volts. Thus, the reverse bias VGS1 is −4.5V calculated by subtracting 5 from 0.5, which is greater than the threshold voltage Vt1 of the first transistor Q1. Similarly, the forward bias VGS2 is 0 volts according to the control signal Vc, which is smaller than the threshold voltage Vt2 of the second transistor Q2. Hence, the first transistor Q1 is turned on, and the second transistor Q2 is turned off.

The second potential Vusb is coupled to the converter 11 when the first transistor Q1 is turned on. When the transistor Q2 is turned off, the converter 11 ceases to supply the fourth potential Vo2 to the TV tuner 16. Thus, the converter 11 only provides a third potential Vo1 only to the video capture device 15. The fourth potential Vo2 is about 3.3V.

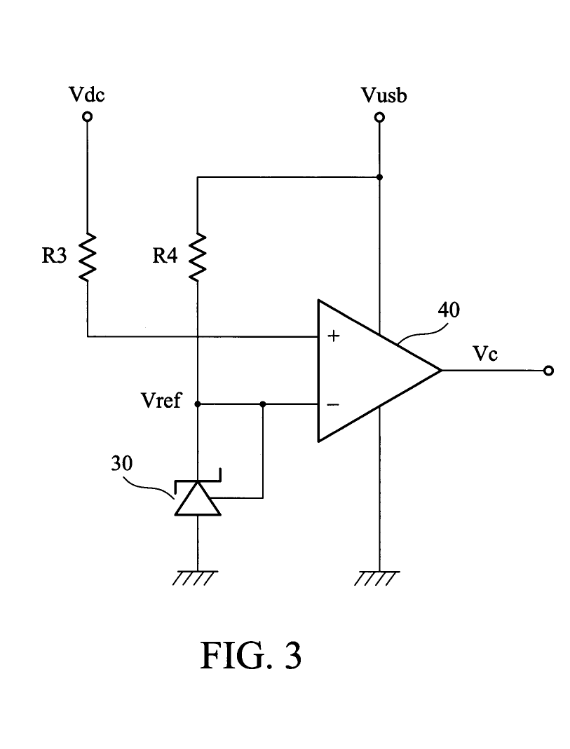

The potential detector 10 can also be implemented by a comparator circuit as showed in FIG. 3. FIG. 3 is a diagram of potential detector 10 of FIG. 2 of the present invention. The comparator circuit comprises a shunt regulator 30, a comparator 40, and a plurality of resistors. The shunt regulator 30 is coupled to the second potential Vusb through a resistor R4, which is capable of providing a reference voltage Vref to the negative input port − of the comparator 40. Additionally, the first potential Vdc is coupled to the positive input port + of the comparator 40 through a resistor R3 to provide a positive potential to the positive port +.

When the potential detector 10 is coupled to the first potential Vdc and the second potential Vusb, the shunt regulator 30 is turned on. When turned on, the shunt regulator 30 is able to provide the reference voltage Vref to the comparator 40. The reference voltage Vref is about 2.495 volts, thus the potential of the negative input port − is equal to 2.495 volts. In addition, the potential of the positive input port + is equal to the first potential Vdc of about 12 volts, which is greater than the potential of the negative input port −. Hence, the comparator 40 outputs the control signal Vc to control the first transistor Q1 and the second transistor Q2, whereby the first transistor Q1 is turned off, and, the second transistor Q2 is turned on.

When the potential detector 10 is not coupled to the first potential Vdc, the potential of the positive input port + is 0 volts and the potential of the negative input port − is equal to the reference voltage Vref, which is about 2.495 volts. Thus, the potential of the positive input port + is smaller than the potential of the negative input port −. Hence, the comparator 40 outputs the control signal Vc with zero potential, and accordingly the first transistor Q1 is turned on and the second transistor Q2 is turned off.

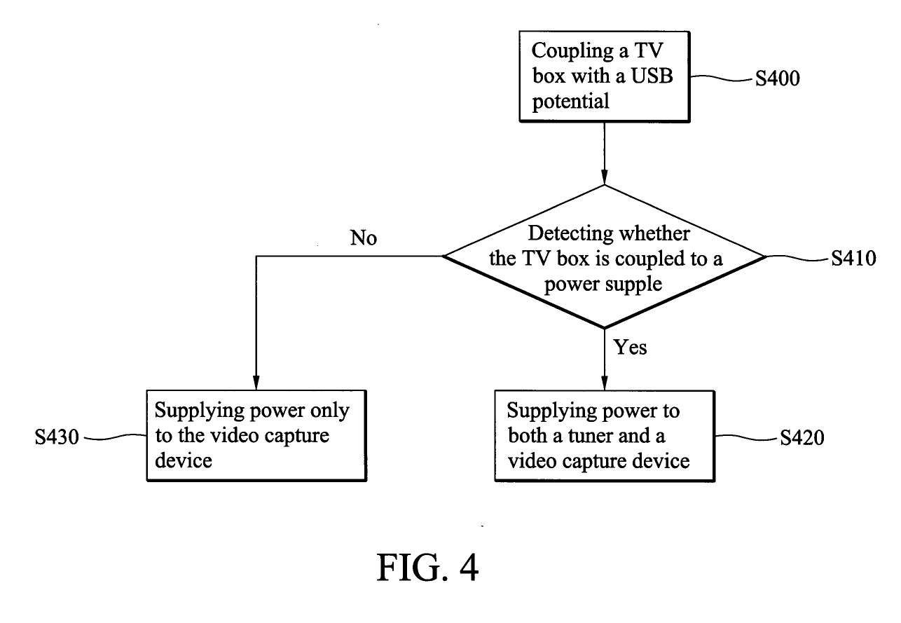

FIG. 4 is a flow chart of the control method of present invention. First, in step S400 a TV box is coupled to a USB potential. Step S410 follows and detects whether the TV box is coupled to an adapter or an additional power source. If the result of step S410 is positive, step 420 follows and supplies power to both the tuner and the video capture device. If the result of step S410 is negative, step 430 follows and supplies power to the video capture device only.

Thus, the video capture device disposed in the TV box can operate normally when the TV box is powered by USB port of a computer host only, thus improving convenience.

Finally, while the invention has been described by way of example and in terms of the above, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

1. An electronic device, comprising:
a tuner;
a video capture device; and
a potential selector;
wherein, when a first potential is applied with the potential selector, both the tuner and the video capture device are powered by a first power source of the first potential, and, when a second potential is applied with the potential selector, the tuner is not powered by a second power source of the second potential.

2. The electronic device as claimed in claim 1, wherein the potential selector further comprises:
a detector, capable of detecting whether the first potential is applied with the potential selector; and
a switch, coupled to the detector, capable of ceasing power transmission the tuner when the first potential is not applied with the potential selector.

3. The electronic device as claimed in claim 2, wherein the switch further comprises:
an input control switch, coupled to the detector, capable of coupling the second power source of the second potential with a power line if the first potential is not applied with the potential selector, and capable of disconnecting the second power source of the second potential and the power line and, coupling the first power source of the first potential to the power line if the first potential is applied with the potential selector; and an output control switch, capable of supplying a third potential to the tuner if the first potential is applied with the potential selector, and disconnecting the connection between the tuner and a third power source of the third potential if the first potential is not applied with the potential selector.

4. The electronic device as claimed in claim 3, wherein the potential selector further comprises:
a converter coupled between the input control switch and the output control switch;
wherein, if the first potential is applied with the potential selector, the converter is capable of converting the first potential into the third potential and a fourth potential to supply power to the tuner and the video capture device, respectively.

5. The electronic device as claimed in claim 4, wherein the input control switch comprises at least a first transistor, and, the output control switch comprises at least a second transistor.

6. The electronic device as claimed in claim 5, wherein, when the first potential is applied with the potential selector, the first transistor is turned off and the second transistor is turned on, and the converter is thereby capable of supplying the third potential to the tuner by converting the first potential.

7. The electronic device as claimed in claim 5, wherein, when the first potential is not applied with the potential selector, the first transistor is turned on and the second transistor is turned off, and the converter is thereby able to be applied with the second potential and ceases to supply the third potential to the tuner.

8. The electronic device as claimed in claim 1, wherein the first potential is greater than the second potential.

9. A control method of an electronic device having a first circuit and a second circuit, wherein the electronic device is coupled to a first power source of a first potential and a second power source of a second potential, the control method comprising:
detecting whether the first potential is applied with the electronic device;
supplying power to the first circuit and the second circuit when the first potential is applied with the electronic device; and
supplying power to the second circuit and not to the first circuit when the first potential is not applied with the electronic device.

10. The control method as claimed in claim 9, wherein the control method further comprises the following steps:
coupling the second power source with a power line when the first potential is not applied with the electronic device; and
disconnecting the connection between the second power source and the power line and applying the first potential to the power line when the first potential is applied with the electronic device;
wherein, the power line is able to be selectively coupled to the first circuit and the second circuit.

11. The control method as claimed in claim 9, further comprising the step of providing a potential detector to determine whether the first potential is applied with the electronic device.

12. The control method as claimed in claim 9, further comprising the following step:
converting the first potential or the second potential into a third potential and a fourth potential.

13. The control method as claimed in claim 12, wherein the third potential is applied to the first circuit and the fourth potential is applied to the second circuit when the first potential is applied with the electronic device.

14. The control method as claimed in claim 13, wherein, the step of supplying power to the second circuit comprises the following steps:
ceasing supply of the third potential to the first circuit; and
supplying the fourth potential to the second circuit.

15. The control method as claimed in claim 9, wherein the first circuit is a tuner and the second circuit is a video capture device.

16. The control method as claimed in claim 9, wherein the first potential is greater than the second potential.
